(19) United States
(12) Patent Application Publication
(10) Pub. No.: US 2010/0085348 A1
(43) Pub. Date: Apr. 8, 2010

(54) DISPLAY DEVICE AND METHOD OF DRIVING THE SAME

(75) Inventors: Hyeon-Seok Bae, Asan-si (KR); Sang -Chul Lee, Yongin-si (KR); Kwang-Youl Lee, Cheonan-si (KR); Hyun-Ho Lee, Seoul (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/469,421

(22) Filed: May 20, 2009

(30) Foreign Application Priority Data
Oct. 8, 2008 (KR) 10-2008-0098677

(51) Int. Cl. G09G 5/00; G09G 3/36

(52) U.S. Cl. 345/213; 345/99

(57) ABSTRACT

A display device and a method of driving the same are provided. The display device includes a display panel including a plurality of pixels defined in an area where a plurality of gate lines and data lines cross one another, a clock generator generating a gate clock signal using a clock generation control signal provided from a timing controller and a gate-on voltage, and a gate driver providing a gate signal to the gate lines in response to the gate clock signal. The gate signal includes a pre-charge period having a first gate-on level and a main-charge period having a second gate-on level that is higher than the first gate-on level.

### CROSS REFERENCE TO RELATED APPLICATION

This application claims priority from and the benefit of Korean Patent Application No. 10-2008-0098677, filed on Oct. 8, 2008, which is hereby incorporated by reference for all purposes as if fully set forth herein.

### BACKGROUND OF THE INVENTION

1. Field of the Invention

The present invention relates to a display device and a method of driving the same.

2. Discussion of the Background

A liquid crystal display (LCD) is provided with a color filter substrate on which a reference electrode, a color filter, and the like are formed, a thin film transistor (TFT) substrate on which a switching element, a pixel electrode, and the like are formed, and a liquid crystal layer interposed between the substrates. The liquid crystal display displays an image by creating an electric field by applying different electric potentials to the pixel electrode and the reference electrode, thereby changing the alignment of liquid crystal molecules in the display, and then adjusting the transmission factor of light accordingly.

As the number of pixels is increased to enhance the resolution of the liquid crystal display, gate signals that are applied to respective gate lines overlap one another in order to effectively charge the respective pixels. This condition can lead to inferior picture quality due to cross talk among pixels.

### SUMMARY OF THE INVENTION

The present invention provides a display device and a method of driving the same that improves picture quality in an LCD display device.

Additional features of the invention will be set forth in the description which follows and in part will be apparent from the description or may be learned by practice of the invention.

The present invention discloses a display device including a display panel including a plurality of pixels defined in an area where a plurality of gate lines and data lines cross one another; a clock generator that generates a gate clock signal based on a clock generation control signal provided by a timing controller and a gate-on voltage; and a gate driver that provides a gate signal to the gate lines in response to the gate clock signal. The gate signal includes a pre-charge period having a first gate-on level and a main-charge period having a second gate-on level that is higher than the first gate-on level.

The present invention also discloses a display device that includes first and second gate lines adjacently arranged in parallel in a first direction; a data line arranged to cross the first and second gate lines; a first pixel connected to the data line and the first gate line; and a second pixel connected to the data line and the second gate line. While the first and second pixels simultaneously receive a data signal through the data line, the amount of current flowing from the data line to the second pixel is smaller than the amount of current flowing from the data line to the first pixel.

The present invention also discloses a method of driving a display device that includes charging pixels connected to a first gate line connected to a first gate line in response to a first gate signal, and charging pixels connected to a second gate line adjacent to the first gate line in response to a second gate signal. The first and second gate signals are signals in the form of ascending steps having a first gate-on level and a second gate-on level that is higher than the first gate-on level, and a period of the first gate-on level of the second gate signal overlaps a period of the second gate-on level of the first gate signal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are intended to provide a further understanding of the invention and are incorporated in and constitute a part of this specification illustrate embodiments of the invention, and together with the description serve to explain the principles of the invention.

FIG. 1 is a block diagram depicting a display device according to an embodiment of the present invention.

FIG. 2 is an equivalent circuit diagram of a pixel depicted in FIG. 1.

FIG. 3 is an exemplary depiction of the structure of pixels depicted in FIG. 1.

FIG. 4 is a schematic depicting gate signals of a display device according to an embodiment of the present invention.

FIG. 5 is a block diagram depicting a display device according to an embodiment of the present invention.

FIG. 6 is a circuit diagram depicting the gate-on voltage provider shown in FIG. 5.

FIG. 7A is a block diagram depicting the clock generator shown in FIG. 5.

FIG. 7B is a circuit diagram depicting the D type flip-flop shown in FIG. 7A.

FIG. 8 is an exemplary block diagram depicting the first gate driver shown in FIG. 5.

FIG. 9 is a circuit diagram depicting a stage shown in FIG. 8.

### DETAILED DESCRIPTION OF THE ILLUSTRATED EMBODIMENTS

The invention is described more fully hereinafter with reference to the accompanying drawings, in which embodiments of the invention are shown. The invention may, however, be embodied in many different forms and should not be construed as limited to the embodiments set forth herein. Rather, these embodiments are provided so that this disclosure is thorough, and willl fully convey the scope of the invention to those skilled in the art. In the drawings, the size and relative sizes if layers and regions may be exaggerated for clarity. Like reference numerals in the drawings denote like elements.

It will be understood that when an element or layer is referred to as being “on” or “conncted” to another element or layer, it can be directly connected to the other layer element or layer or intervening elements or layers may be present. In contrast when an element is referred to as being “directly on” or “directly connected” to another element or layer, there are no intervening elements or layers present.

A display device and a method of driving the same according to an exemplary embodiment of the present invention will now be described in detail with reference to the accompanying drawings.

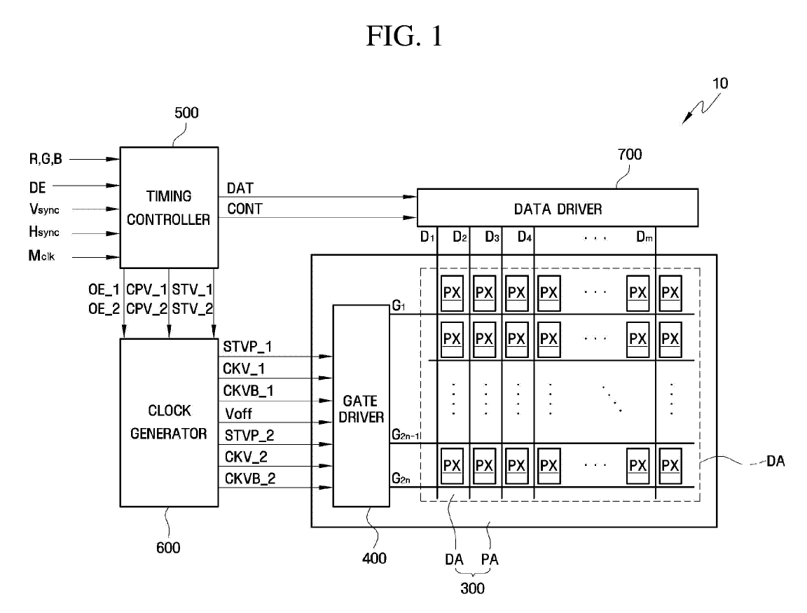

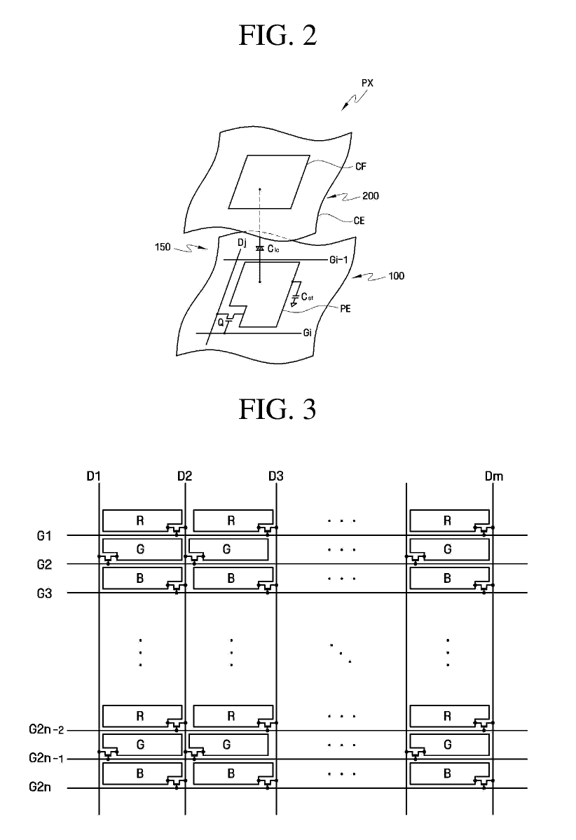

FIG. 1 is a block diagram depicting a display device according to an embodiment of the present invention. FIG. 2 is an equivalent circuit diagram of a pixel shown in FIG. 1, and FIG. 3 is a schematic view depicting the structure of a plurality of the pixels shown in FIG. 1.

Referring to FIG. 1, a display device 10 according to an embodiment of the present invention includes a display panel 300, a timing controller 500, a clock generator 600, a gate driver 400, and a data driver 700.

The display panel 300 is divided into a display area DA where an image is displayed and a non-display area PA where no image is displayed. Here, the non-display area PA may be a part in which a first substrate (See “100” in FIG. 2) is formed to be wider than a second substrate (See “200” in FIG. 2) and in which no image is displayed.

The display area DA includes a first substrate (not shown) where a plurality of gate lines G1 to G2n, a plurality of data lines D1 to Dm, switching elements (not shown), and a pixel electrode (not shown) are formed; a second substrate (not shown) where a color filter (not shown) and a common electrode (not shown) are formed; and a liquid crystal layer (not shown) interposed between the first substrate and the second substrate. The gate lines G1 to G2n extend roughly in rows and are substantially parallel to one another. The data lines D1˜Dm roughly extend in columns and are substantially parallel to one another.

An equivalent circuit of one pixel PX is illustrated in FIG. 2. On a part of a common electrode CE of a second substrate 200, a color filter CF is formed to face a pixel electrode PE of a first substrate 100. For example, a pixel, which is connected to the i-th (where, i=1˜2n) gate line Gi and the j-th (where, j=1˜m) data line Dj, includes a switching element Q connected to signal lines Gi and Dj, a liquid crystal capacitor Clc and a storage capacitor Cst connected to the switching element Q. The switching element Q is a thin film transistor composed of amorphous-silicon (hereinafter referred to as “a-Si TFT”).

As illustrated in FIG. 1 and FIG. 3, the length of each pixel in a direction of the gate lines is longer than the length of the pixel in a direction of the data lines, and RGB color filters are repeatedly arranged in order along the data lines D1 to Dm, so that the pixels connected to the respective gate lines can display the same color. The direction of the data lines may be a direction in which the data lines D1 to Dm extend, and the direction of the gate lines may be a direction in which the gate lines G1 to G2n extend.

The timing controller 500 receives an input image signal RGB and an input control signal for controlling the display of the image signal RGB from an external graphics controller (not shown). The input control signal may include a vertical sync signal Vsync, a horizontal sync signal Hsync, a main clock signal Mclk, a data enable signal DE, and the like. The timing controller 500 generates a data control signal CONT on the basis of the input image signal RGB, and the input control signal, and provides the data control signal CONT and image data DAT to the data driver 700. Also, the timing controller 500 provides a first output enable (OE) signal OE_1, a second OE signal OE_2, a first clock generation control signal CPV_1, a second clock generation control signal CPV_2, a first source scan start signal STV_1, and a second source scan start signal STV_2 to the clock generator 600.

The data driver 700 receives the image signal DAT and the data control signal CONT, and provides an image data signal corresponding to the image signal DAT to the data lines D1˜Dm. Here, the data control signal CONT is a signal for controlling the operation of the data driver 700, and includes a horizontal start signal for starting the operation of the data driver 700, a load signal for commanding the output of two data voltages, and the like. The data driver 700 may be, but is not limited to, an integrated circuit (IC) that is connected to the display panel 300 in the form of a tape carrier package (TCP) or chip on film (COF). In other embodiments of the present invention, the data driver 700 may be formed on the non-display area PA of the display panel 300.

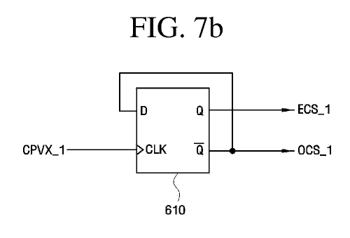

The clock generator 600 generates and provides to the gate driver 400 first and second gate clock signals CKV_1 and CKV_2, first and second gate clock bar signals CKVB_1 and CKVB_2, and first and second scan start signals STVP_1 and STVP_2 by using the first and second OE signals OE_1 and OE_2, the first and second clock generation control signals CPV_1 and CPV_2, and the first and second source scan start signals SV_1 and STV_2. Here, the first gate clock bar signal CKVB_1 and the second gate clock bar signal CKVB_2 may have phases opposite to the first gate clock signal CKV_1 and the second gate clock signal CKV_2, respectively. Detailed construction and operation of the clock generator 600 will be described later with reference to FIG. 7A and FIG. 7B.

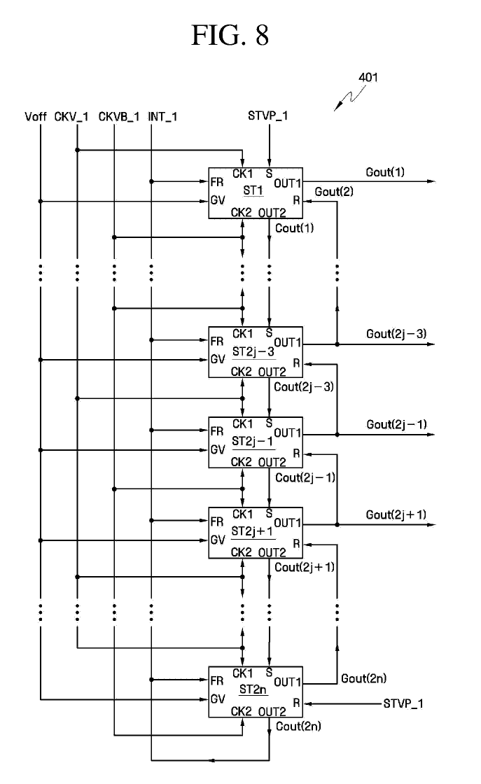

As illustrated in FIG. 1, the gate driver 400 receives the first and second gate clock signals CKV_1 and CKV_2, the first and second gate clock bar signals CKVB_1 and CKVB_2, the first and second scan start signals STVP_1 and STVP_2, and a gate-off voltage Voff, and successively provides gate signals Gout(1) to Gout(2n) (see FIG. 8) to the gate lines G1 to G2n. In the embodiment shown, the gate driver 400 receives the first and second gate clock signals CKV_1 and CKV_2, the first and second gate clock bar signals CKVB_1 and CKVB_2, and the first and second scan start signals STVP_1 and STVP_2. However, the signals received by the gate driver 400 are not limited thereto, and in other embodiments of the present invention, the gate driver 400 may receive three or more gate clock signals, three or more gate clock bar signals, and three or more scan start signals.

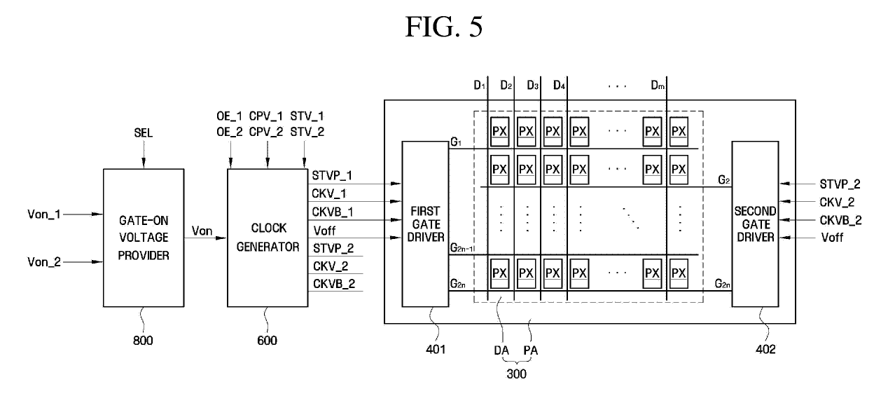

The gate driver 400, as illustrated in FIG. 1, may be formed on the non-display area PA of the display panel 300, and be connected to the display panel 300. However, the gate driver 400 is not limited thereto, and may also be an IC formed as a tape carrier package (TCP) or chip on film (COF). Also, although the gate driver 400 is arranged on one side of the display panel 300 as shown in FIG. 1 for example, it may be divided into a first gate driver 401 and a second gate driver 402 arranged on both sides of the display panel 300 according to another embodiment of the present invention and as shown in FIG. 5.

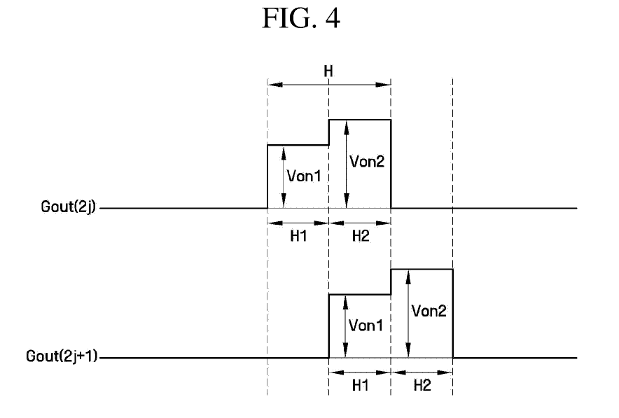

Hereinafter, and with reference to FIG. 1, FIG. 2, FIG. 3, FIG. 4 and FIG. 8, the operation of the display device according to an exemplary embodiment of the present invention will be described.

The gate driver 400 receives the first and second gate clock signals CKV_1 and CKV_2, the first and second gate clock bar signals CKVB_1 and CKVB_2, the first and second scan start signals STVP_1 and STVP_2, and the gate-off voltage Voff from clock generator 600, and provides the gate signals Gout(1) to Gout(2n) to the gate lines G1 to G2n to turn on switching elements connected to the gate lines G1 to G2n. While the gate signal Gout(1) to Gout(2n) is applied to one gate line G1 to G2n to turn on the switching elements Q of one row connected thereto (this period is called “one horizontal period” or “1H”), the data driver 500 provides the respective data signals to the corresponding data line D1 to Dm. The data signal provided to the data line D1 to Dm is applied to a corresponding unit pixel through the turned-on switching element. This changes the electric field generated by the pixel electrode PE and the common electrode CE, and thus the polarization of light passing through the liquid crystal layer 150 is changed. This change of polarization causes a change in the transmission factor of light through a polarizer (not shown) attached to the first substrate 100 and the second substrate 200 resulting from a change in alignment of the liquid crystal molecules.

The gate signals Gout(1) to Gout(2n) are successively applied to all the gate lines G1 to G2n for one frame in the same manner, and thus the data signals are applied to all the unit pixels. For example, if the next frame starts after one frame ends, the state of a reverse signal RVS being applied to the data driver 500 may be controlled (this is called “frame reversal”) so that the polarity of the data signals being applied to the respective unit pixels becomes the reverse of the data signals applied to the respective unit pixels in the previous frame. Moreover, the polarity of the data voltage being applied through the data line can be changed in the same frame (this is called “line reversal”), or the polarity of the data voltage being applied to one pixel row may differ (this is called “dot reversal”) in accordance with the characteristic of the reverse signal RVS.

Hereinafter, turn-on of the switching elements connected to the gate lines G1 to G2n by providing the gate signals Gout(1) to Gout(2n) to the gate lines G1 to G2n will be described in more detail.

FIG. 4 depicts gate signals of a display device according to an embodiment of the present invention. With reference to FIGS. 1 to 4, in a display device according to an embodiment of the present invention, a gate signal Gout(2j) being applied to the first gate line 2j and a gate signal Gout(2j+1) being applied to the second gate line (2J+1) that is adjacent to the first gate line 2j overlap each other. Also, the gate signals Gout(1) to Gout(2n) provided to the respective gate lines G1 to G2n have waveforms in the form of ascending steps having a first gate-on level Von1 and a second gate-on level Von2.

In a display device according to an embodiment of the present invention, each of the gate signals Gout(1) to Gout(2n) being provided to the respective gate lines G1 to G2n includes a pre-charge period H1 having the first gate-on level Von1 and a main-charge period H2 having the second gate-on level Von2 that is higher than the first gate-on level Von1. The main-charge period H2 of the gate signal Gout(1) to Gout(2n) provided to the first gate line 2j and the pre-charge period H1 of the gate signal Gout(1) to Gout(2n) provided to the second gate line (2j+1) overlap each other.

Accordingly, the plurality of pixels connected to the respective gate lines G1 to G2n receive the data signals in order from the data driver 500 through the data lines D1 to Dm wherein they are first pre-charged during the pre-charge period H1 of the gate signal Gout(1) to Gout(2n) being applied to the respective gate lines G1 to G2n, and then receive the data signals in order from the data driver 500 through the data lines D1 to Dm to be main-charged during the main-charge period H2 of the gate signals Gout(1) to Gout(2n). For example, the pixels connected to the (2j+1)-th gate line (G2j+1) may be pre-charged while the pixels connected to the previous 2j-th gate line G2j receive the data signal corresponding to the pixels connected to the 2j-th gate line G2j to be main-charged. Also, the pixels connected to the (2j+1)-th gate line (G2j+1) may receive the corresponding data signal to be main-charged. That is, the pixels connected to the gate lines G1 to G2n receive the data signal corresponding to the pixels connected to the previous row to be pre-charged before they receive the corresponding data signal to be charged (i.e. main-charged).

However, in the case where the main-charge period H2 of the gate signal Gout(2j) being provided to the first gate line 2j and the pre-charge period Hi of the gate signal Gout(2j+1) being provided to the second gate line (2j+1) overlap each other, and the pixels connected to the second gate line (2j+1) are pre-charged, crosstalk may occur between the pixels connected to the first gate line 2J and the pixels connected to the second gate line (2J+1) thereby degrading picture quality.

To address this issue, in an embodiment of the present invention, the gate signals Gout(1) to Gout(2n) being applied to the gate lines G1 to G2n include the pre-charge period H1 having the first gate-on level Von1 and the main-charge period H2 having the second gate-on level Von2 that is higher than the first gate-on level Von1, thereby reducing the degradation of picture quality. That is, in an embodiment of the present invention, the gate signal Gout(1) to Gout(2n) has the lower level in the pre-charge period H1 rather than the main-charge period H2, and thus the pixel PX that is pre-charged by receiving the data signal being applied to the pixel of the previous row is prevented from being relatively overcharged.

Specifically, while the switching element Q connected to the first gate line 2j receives the gate signal Gout(2j) of the second gate-on level Von2 to be turned on, the switching element Q connected to the second gate line (2J+1) receives the gate signal Gout(2J+1) of the first gate-on level Von1 to be turned on. Also, as the data signal is provided through the turned-on switching element Q, the pixels connected to the first gate line 2j are main-charged, and the pixels connected to the second gate line (2j+1) are pre-charged. However, since the level of the gate signal Gout(2J+1) being provided to the switching element Q connected to the second gate line (2J+1) is lower than the level of the gate signal Gout(2j) being provided to the switching element Q connected to the first gate line 2j, the amount of current flowing from the data lines D1 to Dm to the pixels connected to the second gate line (2J+1) may be smaller than the amount of current flowing from the data lines D1 to Dm to the pixels connected to the first gate line 2j. Accordingly, even if the gate signals Gout(2j) and Gout(2j+1) being applied to the first gate line 2j and the second gate line (2j+1) overlap each other, the inferiority of picture quality occurring due to the crosstalk between the pixels connected to the first gate line 2j and the pixels connected to the second gate line (2j+1) can be reduced. That is, even if the gate signals Gout(2j) and Gout(2j+1) being applied to the first gate line 2j and the second gate line (2j+1) overlap each other, the pixels connected to the second gate line (2J+1), which receive the data signal corresponding to the pixels connected to the first gate line 2j, are prevented from being overcharged.

On the other hand, in a display device according to the embodiments of the present invention, lengths of the pre-charge period H1 and the main-charge period H2 of the gate signals Gout(1) to Gout(2n) and/or the first gate-on level Von1 and the second gate-on level Von2 may be adjusted to prevent the pixels from being overcharged. For example, the lengths of the pre-charge period H1 and the main-charge period H2 of the gate signals Gout(1) to Gout(2n) may be set to be equal to each other. Also, in order to prevent the pixels from being overcharged as effectively pre-charging the pixels, the first gate-on level Von1 in the pre-charge period H1 may be higher than a half of the second gate-on level Von2 in the main-charge period H2.

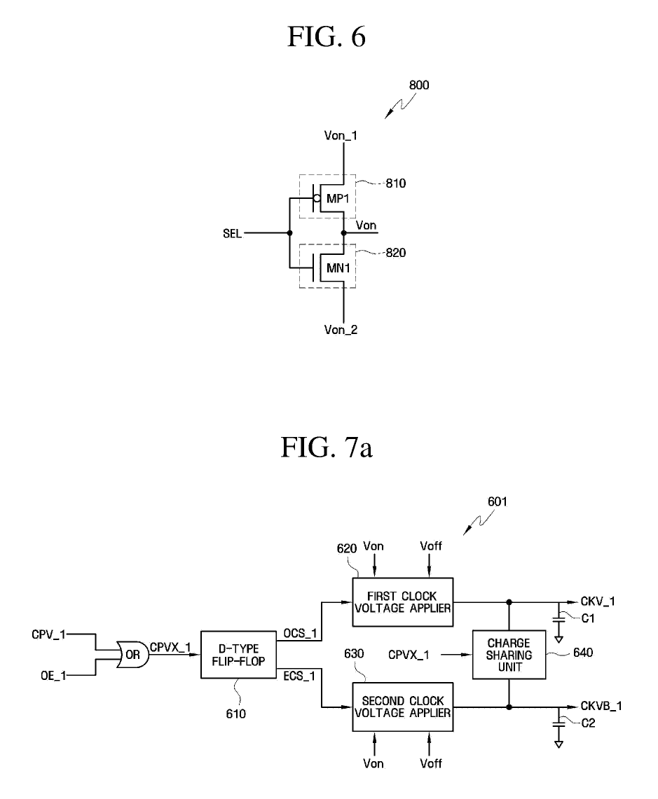

Hereinafter, with reference to FIG. 5, FIG. 6, FIG. 7A, FIG. 7B, and FIG. 8, a display device according to an embodiment of the present invention will be described.

FIG. 5 is a block diagram depicting a display device according to an embodiment of the present invention, and FIG. 6 is an exemplary circuit diagram of a gate-on voltage provider of FIG. 5. For ease of presentation, FIG. 5 mainly illustrates a gate driver and gate lines, but a timing controller, a date driver, and the like are omitted.

Referring to FIG. 5, the display device according to an embodiment of the present invention includes a gate-on voltage provider 800, a clock generator 600, first and second gate drivers 401 and 402, and the like.

The gate-on voltage provider 800 receives a first gate-on voltage Von_1 and a second gate-on voltage Von_2, and provides a gate-on voltage Von to the clock generator 600 in response to a selection signal SEL. Specifically, the gate-on voltage provider 800 receives the first gate-on voltage Von_1 and the second gate-on voltage Von_2 from a power generator (not illustrated), and selectively provides the first gate-on voltage Von_1 or the second gate-on voltage Von_2 to the clock generator 600 as the gate-on voltage Von in response to the selection signal SEL. Here, the selection signal SEL may be a square wave provided from the timing controller 500, and lengths of the period of the first gate-on voltage and the period of the second gate-on voltage may differ in accordance with a high-level period and a low-level period of the selection signal SEL.

The gate-on voltage provider 800, as illustrated in FIG. 6, includes a first gate-on voltage provider 810 and a second gate-on voltage provider 820. The first gate-on voltage provider 810 may be a PMOS transistor MP1 connected between nodes of the first gate-on voltage Von_1 and the gate-on voltage Von and receiving the selection signal SEL through its gate. The second gate-on voltage provider 820 may be an NMOS transistor MN1 connected between nodes of the second gate-on voltage Von_2 and the gate-on voltage Von and receiving the selection signal SEL through its gate. Accordingly, the first and second gate-on voltage providers 810 and 820 selectively provide the first gate-on voltage Von_1 or the second gate-on voltage Von_2 as the gate-on voltage Von in response to the selection signal SEL.

The clock generator 600 provides the first and second gate clock signals CKV_1 and CKV_2, and the first and second gate clock bar signals CKVB_1 and CKVB_2 by using the first and second OE signals OE_1 and OE_2, and the first and second clock generation control signals CPV_1 and CPV_2, and includes a first clock generator and a second clock generator. Here, the first clock generator provides the first gate clock signal CKV_1 and the first gate clock bar signal CKVB_1 to the first gate driver 401 by using the first OE signal OE_1 and the first clock generation control signal CPV_1. Similarly, the second clock generator provides the second gate clock signal CKV_2 and the second gate clock bar signal CKVB_2 to the second gate driver 402 by using the second OE signal OE_2 and the second clock generation control signal CPV_2.

Hereinafter, with reference to FIG. 7A and FIG. 7B, the clock generator will be described in more detail. FIG. 7A is a block diagram explaining a clock generator of FIG. 5, and FIG. 7B is an exemplary circuit diagram explaining a D type flip-flop of FIG. 7A.

Referring to FIG. 7A and FIG. 7B, the first clock generator 601 includes an OR gate OR, a D-type flip-flop 610, a first clock voltage applier 620, a second clock voltage applier 630, and a charge sharing unit 640. It should be noted that elements of the first clock generator may vary and thus the circuitry of the first clock generator 601 is not limited thereto.

The OR gate OR receives and OR-gates the first OE signal OE_1 and the first clock generation control signal CPV_1, and generates and provides a charge sharing control signal CPVX_1 to the D-type flip-flop 610.

The D-type flip-flop 610, as illustrated in FIG. 7A, receives the charge sharing control signal CPVX_1 through its clock terminal CLK. Since an input terminal D is connected to an output terminal Q-bar, the D-type flip-flop 610 outputs a second clock enable signal ECS_1 that is toggled at every rising edge of the charge sharing control signal CPVX_1 through one output terminal Q, and outputs a first clock enable signal OCS_1 having a phase opposite to a phase of the second clock enable signal ECS_1 through the other output terminal Q-bar.

The first clock enable signal OCS_1 is provided to the first clock voltage applier 620, and the second clock enable signal ECS_1 is provided to the second clock voltage applier 630.

The first clock voltage applier 620 is enabled by the first clock enable signal OCS_1, and outputs the first gate clock signal CKV_1, which has the gate-on voltage level Von if the first clock enable signal OCS_1 is at a high level, and has the gate-off voltage level Voff if the first clock enable signal OCS_1 is at a low level. Also, the second clock voltage applier 630 is enabled by the second clock enable signal ECS_1, and outputs the first gate clock bar signal CKVB_1, which has the gate-on voltage level Von if the second clock enable signal ECS_1 is at a high level, and has the gate-off voltage level Voff if the second clock enable signal ECS_1 is at a low level.

Here, the gate-on voltage Von provided to the first and second clock voltage appliers 620 and 630 may have the first gate-on voltage level Von_1 or the second gate-on voltage level Von_2 in accordance with the selection signal SEL provided to the gate-on voltage provider 800. Accordingly, the first gate clock signal CKV_1 and the first gate clock bar signal CKVB_1 provided from the clock generator 600 may be signals in the form of ascending steps having the first gate-on voltage level Von_1 and the second gate-on voltage level Von_2.

The charge sharing unit 640 receives the charge sharing control signal CPVX_1, and shares charges when the first gate clock signal CKV_1 and the first gate clock bar signal CKVB_1 are charged and discharged. Specifically, the charge sharing unit 640 can easily perform charging of a first capacitor C1 and discharging of a second capacitor C2, or perform discharging of the first capacitor C1 and charging of the second capacitor C2 by electrically connecting the first capacitor C1 and the second capacitor C2 in response to the charge sharing control signal CPVX_1. In another embodiment of the present invention, the display device may not include the charge sharing unit 640.

The second clock generator may have substantially the same construction and operation as those of the first clock generator 601 as described above. That is, in a similar manner to the first clock generator 601, the second clock generator provides the second gate clock signal CKV_2 and the second gate clock bar signal CKVB_2 in the form of ascending steps having the first gate-on voltage level Von_1 and the second gate-on voltage level Von_2 by using the second OE signal OE_2 and the second clock generation control signal CPV_2.

Here, the first gate-on voltage level period of the second gate clock signal CKV_2 may overlap the second gate-on voltage level period of the first gate clock signal CKV_1 provide from the first clock generator 601. Similarly, the first gate-on voltage level period of the second gate clock bar signal CKVB_2 provided from the second clock generator may overlap the second gate-on voltage level period of the first gate clock bar signal CKVB_1 provided from the first clock generator.

The gate driver includes first and second gate drivers 401 and 402 formed on the display panel 300. The first gate driver 401 receives the first gate clock signal CKV_1, the first gate clock bar signal CKVB_1, the first gate scan start signal STVP_1 and the gate-off voltage Voff, and provides the gate signals Gout(1) to Gout(2n−1) to the odd-numbered gate lines G1 to (G2n−1). Also, the second gate driver 402 receives the second gate clock signal CKV_2, the second gate clock bar signal CKVB_2, the second gate scan start signal STVP_2 and the gate-off voltage Voff, and provides the gate signals Gout(2) to Gout(2n) to the even-numbered gate lines G2 to G2n.

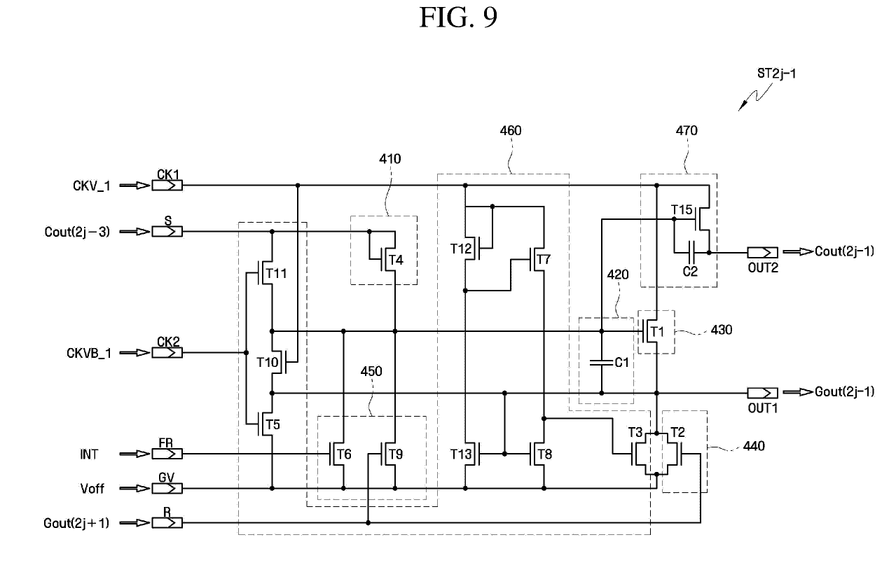

Hereinafter, with reference to FIG. 8 and FIG. 9, the first and second gate drivers will be described in detail. FIG. 8 is an exemplary block diagram depicting a first gate driver of FIG. 5, and FIG. 9 is an exemplary circuit diagram explaining a stage of FIG. 8.

The first gate driver 401 includes a plurality of stages ST1 to ST2n. The respective stages ST1 to ST2n are connected in cascading fashion with one another, and the respective stages ST1 to (ST2n−1), except for the last stage ST2n, are connected to the odd-numbered gate lines G1 to (G2n−1) in a one-to-one manner to output the gate signals Gout(1) to Gout(2n−1). The gate-off voltage Voff, the first gate clock signal CBV_1, the first gate clock bar signal CKVB_1, and an initialization signal INT_1 are inputted to the respective stages St1 to ST2n. Here, the initialization signal INT_1 may be provided from the clock generation unit 600.

The respective stages ST1 to ST2n may have a first clock terminal CK1, a second clock terminal CK2, a set terminal S, a reset terminal R, a supply voltage terminal GV, a frame reset terminal FR, a gate output terminal OUT1, and a carry output terminal OUT2.

For example, as FIG. 8 shows, a carry signal Cout(2j−3) of a front end stage (ST2j−3) is inputted to the set terminal S of a rear end stage (ST2j−1) connected to the (2j−1)-th gate line, and a gate signal Gout(2j−1) of the rear end stage (ST2j−1) is inputted to the reset terminal R of the front end stage (ST2j−3). The first gate clock signal CKV_1 and the first gate clock bar signal CKVB_1 are inputted to the first clock terminal CK1 and the second clock terminal CK2, respectively, and the initialization signal INT_1 or a carry signal Cout(2n) of the last stage ST2n is inputted to the frame reset terminal FR. The gate signal Gout(2j−1) is outputted from the gate output terminal OUT1, and the carry signal Cout(2j−1) is outputted from the carry output terminal OUT2 of the stage (ST2j−1).

However, the first scan start signal STVP_1, instead of the front end carry signal, is inputted to the set terminal S of the first stage ST1, and the first scan start signal STVP_1, instead of the rear end gate signal, is inputted to the reset terminal R of the last stage ST2n.

Here, with reference to FIG. 9, one stage (ST2j−1) of FIG. 8 will be described in more detail.

Referring to FIG. 9, the stage (ST2j−1) includes a buffer unit 410, a charge unit 420, a pull-up unit 430, a carry signal generator 470, a pull-down unit 440, a discharge unit 450, and a holding unit 460.

The buffer unit 410 has a gate commonly connected to the drain of a transistor T4, and provides the carry signal Cout(2j−3) of the front end stage (ST2j−3) inputted through the set terminal S to the charge unit 420, the carry signal generator 470, and the pull-up unit 470 connected to the source thereof.

The charge unit 420 includes a capacitor C3 having one end connected to the source of the transistor T4, the pull-up unit 430, and the discharge unit 450, and the other end connected to the gate output terminal OUT1. The charge unit 420 receives the carry signal Cout(2j−3) of the front end stage (ST2j−3) to be charged.

The pull-up unit 430 includes a transistor T1. The drain of the transistor T1 is connected to the first clock terminal CK1, the gate thereof is connected to one end of the capacitor C3, and the source thereof is connected to the other end of the capacitor C3 and the gate output terminal OUT1. If the capacitor C3 of the charge unit 420 is charged, the transistor T1 is turned on to provide the first gate clock signal CKV_1 inputted through the first clock terminal CK1 to the gate output terminal OUT1 as the gate signal Gout(2j−1).

The carry signal generator 470 includes a transistor T15 having a drain connected to the first clock terminal CK1, a source connected to the carry output terminal OUT2, and a gate connected to the buffer unit 410, and a capacitor C4 connected to the gate and source of the transistor T15. The capacitor C4 receives the carry signal Cout(2j−3) of the front end stage (ST2j−3) to be charged, and if the capacitor C4 is charged, the transistor T15 is turned on to output the first gate clock signal CKV_1 through the carry output terminal OUT2 as the carry signal Cout(2j−1).

The pull-down unit 440 includes a transistor T2 having a drain connected to the source of the transistor T1 and the other end of the capacitor C3, a source connected to the supply voltage terminal GV, and a gate connected to the reset terminal R. The pull-down unit 440 is turned on by the gate signal of the next stage (ST2j+1) inputted through the reset terminal R to pull down the gate signal Gout(2j−1) to the gate off voltage Voff.

The discharge unit 450 includes a transistor T9 having a gate connected to the reset terminal R, a drain connected to one end of the capacitor C3, and a source connected to the supply voltage terminal GV, and discharging the charge unit 420 in response to the gate signal Gout(2j+1) of the next stage (ST2j+1); and a transistor T6 having a gate connected to the frame reset terminal FR, a drain connected to one end of the capacitor C3, and a source connected to the supply voltage terminal GV, and discharging the charge unit 420 in response to the initialization signal INT_1. That is, the discharge unit 450 turns off the pull-up unit 430 by discharging the capacitor C3 to the gate off voltage Voff in response to the gate signal Gout(2j+1) of the next stage (ST2j+1) or the initialization signal INT_1.

The holding unit 460 keeps the gate signal Gout(2j−1) at a high level when the gate signal Gout(2j−1) is changed from a low level to a high level, while it keeps the gate signal Gout(2j−1) at a low level for one frame, irrespective of the voltage levels of the first gate clock signal CKV_1 and the first gate clock bar signal CKVB_1, after the gate signal Gout(2j−1) is changed from the high level to the low level.

More specifically, when the gate signal Gout(2j−1) is first changed from the low level to the high level, the transistors T8 and T13 are turned on. The transistor T13 turns off the transistor T7 to intercept the first gate clock signal CKV_1 of a high level that is provided to the transistor T7, and transistor T8 turns off the transistor T3. Accordingly, the gate signal Gout(2j−1) is kept at a high level.

After the gate signal Gout(2j−1) is changed from the high level to the low level, the transistors T8 and T13 are turned off. If the first gate clock signal CKV1 is at a high level, the transistors T7 and T12 turn on the transistor T3 to keep the gate signal Gout(2j−1) at a low level. Also, the transistor T10 is turned on to keep the gate of the transistor T1 at a low level. Accordingly, the first gate clock signal CKV_1 of a high level is not outputted to the gate output terminal OUT1. If the first gate clock bar signal CKVB_1 is at a high level, the transistors T5 and T11 are turned on. The turned-on transistor T5 keeps the gate signal Gout(2j−1) at a low level, and the turned-on transistor T11 keeps the one end of the capacitor C3 at a low level. Accordingly, the gate signal Gout(2j−1) is kept at a low level for one frame.

However, the stage (ST2j−1) may not include the carry signal generator 470. In this case, the stage (ST2j−1) receives the gate signal Gout(2j−3) of the front end stage (ST2j−3) through its set terminal, instead of the carry signal Cout(2j−3) of the front end stage (ST2j−3).

The second gate driver 402 is substantially the same as the first gate driver 401. That is, as illustrated in FIG. 8, the second gate driver 402 includes a plurality of stages connected in cascade with one another, and the respective stages are connected to the even-numbered gate lines G2 to G2n in a one-to-one manner. As illustrated in FIG. 9, the respective stages may have the same inner construction. For convenience in explanation, detailed description of the second gate driver 402 will be omitted.

It will be apparent to those skilled in the art that various modifications and variations can be made in the present invention without departing from the spirit or scope of the invention. Thus it is intended that the present invention cover the modifications and variations of this invention provided they come within the the scope of the appended claims and their equivalents.

What is claimed is:

1. A display device, comprising:
a display panel comprising a plurality of pixels connected to a plurality of gate lines and data lines which are formed over the gate lines;
a clock generator to generate a gate clock signal using a clock generation control signal and a gate-on voltage; and
a gate driver to provide a gate signal to the gate lines in response to the gate clock signal;
wherein the gate signal comprises a pre-charge period having a first gate-on level and a main-charge period having a second gate-on level that is higher than the first gate-on level.

2. The display device of claim 1, wherein the plurality of gate lines comprises a first gate line and a second gate line adjacent to the first gate line; and the main-charge period of the gate signal provided to the first gate line and the pre-charge period of the gate signal provided to the second gate line overlap each other.

3. The display device of claim 2, wherein the first gate-on level is higher than half of the second gate-on level.

4. The display device of claim 2, wherein a length of the pre-charge period is equal to a length of the main-charge period.

5. The display device of claim 1, wherein the gate clock signal is a signal in the form of ascending steps comprising the first gate-on level and the second gate-on level.

6. The display device of claim 5, further comprising a gate-on voltage provider to selectively provide a first gate-on voltage or a second gate-on voltage to the clock generator as the gate-on voltage in response to a selection signal.

7. The display device of claim 1, wherein the gate clock signal provided by the clock generator comprises a first gate clock signal and a second gate clock signal; and the odd-numbered gate lines among the plurality of gate lines receive the gate signal in response to the first gate clock signal, and the even-numbered gate lines among the plurality of gate lines receive the gate signal in response to the second gate clock signal.

8. The display device of claim 7, wherein the first gate clock signal and the second gate clock signal are signals in the form of ascending steps comprising a first period comprising the first gate-on level and a second period comprising the second gate-on level; and the first period of the first gate clock signal and the second period of the second gate clock signal overlap each other.

9. The display device of claim 1, wherein a length of the pixel in a direction the gate line extends is longer than a length of the pixel in a direction the data line extends, and all pixels connected to the same gate line display the same color.

10. A display device, comprising:
a first gate line and a second gate line adjacently arranged in parallel in a first direction;
a data line arranged over the first gate line and the second gate line;
a first pixel connected to the data line and the first gate line; and
a second pixel connected to the data line and the second gate line;
wherein the first and second pixels simultaneously receive a data signal from the data line, and the amount of current flowing from the data line to the second pixel is smaller than the amount of current flowing from the data line to the first pixel.

11. The display device of claim 10, further comprising a gate driver to successively provide gate signals to the first and second gate lines in response to a gate clock signal, the gate signals being in the form of ascending steps comprising a first gate-on level and a second gate-on level;
wherein a period where the level of the gate signal provided to the first gate line is the second gate-on level overlaps a period where the level of the gate signal provided to the second gate line is the first gate-on level.

12. The display device of claim 11, wherein the first gate-on level of the gate signal is higher than half of the second gate-on level of the gate signal.

13. The display device of claim 11, further comprising a gate clock generator to provide the gate clock signal by using a first gate-on voltage and a second gate-on voltage;
wherein the gate clock signal is a signal in the form of ascending steps comprising a first level and a second level that is higher than the first level.

14. The display device of claim 13, wherein the gate clock signal comprises a first gate clock signal and a second gate clock signal; and the gate driver provides the gate signal to the first gate line in response to the first gate clock signal, and provides the gate signal to the second gate line in response to the second gate clock signal.

15. The display device of claim 11, wherein the first and second pixels are pre-charged in response to the gate signal of the first gate-on level, and are main-charged in response to the gate signal of the second gate-on level.

16. The display device of claim 10, wherein a length of the first pixel in a direction the first gate line extends is longer than a length of the first pixel in a direction the data line extends, and all pixels connected to the same gate line display the same color.

17. A method of driving a display device, comprising:
charging pixels connected to a first gate line in response to a first gate signal; and
charging pixels connected to a second gate line adjacent to the first gate line in response to a second gate signal;
wherein the first gate signal and the second gate signal are signals in the form of ascending steps comprising a first gate-on level and a second gate-on level that is higher than the first gate-on level, and a period of the first gate-on level of the second gate signal overlaps a period of the second gate-on level of the first gate signal.

18. The method of claim 17, wherein the first gate-on level is higher than half of the second gate-on level.

19. The method of claim 17, wherein the pixels connected to the first gate line are pre-charged during the period of the first gate-on level of the first gate signal, and are main-charged during the period of the second gate-on level of the first gate signal; while the pixels connected to the second gate line are pre-charged during the period of the first gate-on level of the second gate signal, and are main-charged during the period of the second gate-on level of the second gate signal.

20. The method of claim 17, further comprising respectively providing the first gate signal and the second gate signal to the first gate line and the second gate line in response to a gate clock signal;
wherein the gate clock signal is a signal in the form of ascending steps comprising the first gate-on level and the second gate-on level.
